(19) United States
(12) Patent Application Publication
(10) Pub. No.: US 2005/0176838 A1
(43) Pub. Date: Aug. 11, 2005

(54) Method for the production of polyurethane foam materials

(76) Inventors: Dieter Rodewald, Ludwigshafen (DE); Bernd Bruchmann, Freinsheim (DE); Horst Binder, Lampetheim (DE); Heinz-Dieter Lutter, Diepholz (DE); Ansgar Frericks, Osnabruck (DE); Markus Templin, Lemforde (DE); Martin Kreyenschmidt, Lohne (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/516,074

(22) PCT Filed: Jun. 6, 2003
(86) PCT No.: PCT/EP03/05935

(30) Foreign Application Priority Data
Jun. 13, 2002 (DE) 102 26 414.7

(51) Int. Cl. C08J 9/00

(52) U.S. Cl. 521/155

(57) ABSTRACT

Polyurethane foams having a density of less than 200 g/l are prepared by reacting a) polyisocyanates with b) compounds having at least two hydrogen atoms reactive with isocyanate groups, the polyisocyanates a) being aromatic di- or polyisocyanates and the compounds b) having at least two hydrogen atoms reactive with isocyanate groups containing at least one acrylate polyol.

The present invention relates to a process for the preparation of polyurethane foams, in particular flexible and semirigid polyurethane foams, by reacting polyisocyanates with compounds having at least two hydrogen atoms reactive with isocyanate groups.

Polyurethane foams have long been known and are widely described in the literature. They are usually prepared by reacting isocyanates with compounds having at least two hydrogen atoms reactive with isocyanate groups. Isocyanates generally used are aromatic di- and polyisocyanates, isomers of tolylene diisocyanate (TDI), isomers of diphenylmethane diisocyanate (MDI) and mixtures of diphenylmethane diisocyanate and polymethylenepolyphenylene polyisocyanates (crude MDI) being of greatest industrial importance.

Like biological materials, polyurethane foams are subject to an aging process which generally leads to a significant deterioration in the performance characteristics with increasing time. Substantial aging influences are, for example, hydrolysis, photooxidation and thermal oxidation, which lead to the cleavage of bonds in the polymer chain. In the case of polyurethane materials, the action of moisture and elevated temperatures in particular leads to the hydrolytic cleavage of the urethane and urea bonds. High thermal loads without additional strong action of moisture can also lead to cleavage of urethane and urea bonds. This cleavage is evident not only in a significant deterioration in the performance characteristics but also leads to the formation of aromatic amines, such as toluenediamine (TDA) and diaminodiphenylmethane (MDA).

The amine formation is influenced by a number of parameters. Particularly low indices lead to measurable contents of aromatic amine in polyurethanes, even without aging. Such low indices are used in particular in the case of very flexible, viscoelastic foam qualities, which are employed to prevent bed sores or sores caused by prolonged sitting, for example as wheelchair cushions. Furthermore, high temperatures, particularly in combination with high atmospheric humidity, lead to the cleavage of the urethane and urea bonds. Such bonds are important for some specific applications of flexible PU foams. Hospital mattresses, which are subjected to sterilization with superheated steam, constitute an example of such special applications. There may also be a deterioration in the mechanical properties in this procedure. For this reason, the less drastic disinfection with superheated steam according to DIN 13 014 (105° C.; max. 10 min) is frequently carried out. Upholstered furniture which is cleaned in the household by means of cleaners employing superheated steam constitute a further example. Apart from these special applications, however, contamination with aromatic amines is not to be expected when products of flexible and semirigid PU foams are used in the intended manner.

A further parameter which significantly influences the formation of aromatic amines and/or also the aging resistance under warm or humid and warm conditions is the type and amount of the catalysts used. The catalysts contained in polyurethane systems and required for the urethanization and blowing reaction also catalyze the cleavage reaction to a considerable extent. The presence of catalysts is thus essential for the cleavage of the urethane and urea bonds. Moreover, the extent of the cleavage depends to a great extent on the activity and the type of the catalyst and on whether the catalyst remains in the system or can migrate out of the material. In particular, tertiary amine catalysts having reactive functional groups, such as OH and NH₂ groups, accelerate the amine formation in the polyurethane by considerably reducing the activation energy for the cleavage reaction. The functional groups result in the incorporation of the catalysts into the polyurethane network formed, and the products thus prepared have the advantage of less problems with odor and fogging, but the catalysts cannot escape by diffusion after complete preparation of the polyurethane. The same applies to formulations with polyols which were prepared using primary or secondary amines as initiator molecules and thus have catalytically active centers which are present in the foam. Such polyols have recently been increasingly used. On the other hand, in the case of foams comprising amine catalysts, which contain no incorporatable functional groups, the amines escape as a rule in a short time after complete preparation or during the aging of the foam. In the case of such foams, for example, strong hydrolytic stresses lead to substantially lower amine contents and/or to a smaller deterioration in the performance characteristics during aging.

In order to reduce the liberation of aromatic amines and/or to improve the aging resistance under warm or humid and warm conditions in the case of polyurethane materials, preferably those which are prepared with low indices or which are exposed to particular climatic conditions, it was necessary to find additives which prevent the migration of resulting aromatic amines from the foam or the formation of aromatic amines under climatic stress and/or improve the aging resistance under warm or humid and warm conditions.

A number of solutions are known for chemically binding aromatic amines formed. Thus, according to DE 19919826-A1, α,β-unsaturated carboxylic acid derivatives can be used. These compounds frequently have a low molecular weight or contain low molecular weight polymerization stabilizers and can therefore contribute to undesired emissions from the foam. Furthermore, they can adversely affect the foam structure (coarse cell character). U.S. Pat. No. 5,990,232 describes the use of unsaturated carbonyl compounds, in particular carboxylic acids, in the polyol preparation by means of DMC catalysts. These unsaturated polyols are used for stabilizing polymer polyols. According to U.S. Pat. No. 4,211,847, GB 1565124 and DE-A 2946625, sterically hindered cycloaliphatic monoisocyanates and monothioisocyanates can be used for the reduction of aromatic amines and polyurethanes. The disadvantage here is the relatively high price of these products and their low vapor pressure, which results in unconverted fractions migrating out of the foam and constituting a health hazard owing to the occurrence of free isocyanate.

It is an object of the present invention to provide flexible and semirigid polyurethane foams, in particular viscoelastic flexible and semirigid polyurethane foams, in which the formation of free aromatic amines is substantially reduced even under humid storage conditions, which have good mechanical properties and/or whose aging resistance under warm or humid and warm conditions is improved.

We have found, surprisingly, that this object is achieved and that polyurethane foams which were prepared using polyols based on modified acrylate or methacrylate monomers have, after storage under humid and warm conditions, substantially lower contents of aromatic amines than polyurethane foams which were based on conventional polyetherols which were comparable in hydroxyl number and molecular weight to the polyols based on modified acrylate or methacrylate monomers. Furthermore, an improvement in the aging resistance under warm or humid and warm conditions can be achieved by using these polyols based on acrylate or methacrylate monomers. The acrylate polyols used according to the invention possibly impart hydrophobic properties to the foam so that hydrolytic degradation with liberation of aromatic amines is at least partly suppressed owing to reduced water absorption of the foam. Alternatively, an initial hydrolysis of the acrylic or methacrylic ester side chains with generation of free acid groups is conceivable under humid and warm conditions. These acid groups can then protonate amine catalysts present in the foam and thus deactivate them. These protonated catalysts can then no longer catalyze the cleavage of urethane or urea bonds in the foam with liberation of aromatic amines, resulting in lower contents of aromatic amines in aged foams and/or smaller deteriorations in the mechanical properties after aging under warm or humid and warm conditions.

The present invention accordingly relates to a process for the preparation of polyurethane foams, preferably flexible and semirigid polyurethane foams, in particular viscoelastic flexible and semirigid polyurethane foams, by reacting
a) polyisocyanates with
b) compounds having at least two hydrogen atoms reactive with isocyanate groups,
   the polyisocyanates a) being aromatic di- and/or polyisocyanates and the compounds b) having at least two hydrogen atoms reactive with isocyanate groups containing at least one acrylate polyol.

Viscoelastic foams are understood as meaning flexible and semirigid foams having very low resilience, for example <50%, in particular <40%.

The present invention furthermore relates to polyol mixtures containing at least one acrylate polyol and at least one further alcohol, preferably an at least difunctional polyetheralcohol or a polyesteralcohol.

Preferably used acrylate polyols are low molecular weight acrylate polyols, i.e. those whose number average molecular weight is not more than 12 000, preferably not more than 8000, particularly preferably not more than 6000, g/mol and at least 400 g/mol. The terms acrylate polyols and polyacrylate polyols are used synonymously below.

The acrylate polyols used according to the invention can be prepared by polymerization of hydroxyl-functionalized (meth)acrylates, preferably by copolymerization of hydroxyl-functionalized (meth)acrylates, with (meth)acrylates which do not have hydroxyl functional groups. Furthermore, they can also be prepared by copolymerization of said acrylate monomers with other aliphatic or aromatic, ethylenically unsaturated monomers, for example ethene, propene, butene, isobutene, diisobutene, acrylonitrile, acrylamide, acrolein, styrene, methylstyrene, divinylbenzene, maleic anhydride, vinyl esters of carboxylic acids or unsaturated carboxylic acids, such as maleic acid, fumaric acid or crotonic acid or derivatives thereof.

Such copolymerizations can be carried out in continuous or batchwise reactors, for example kettles, annular gap reactors, Taylor reactors, extruders or tubular reactors.

Reaction conditions which lead to polymers having a low content of impurities are preferably chosen. Thus, in the preparation of the acrylate polyols used according to the invention, the procedure is preferably carried out without the use of polymerization regulators.

In the preparation of the acrylate polyols used according to the invention, polymerization is preferably effected at above 160° C. in the absence of polymerization regulators and at very low initiator concentrations. The process is preferably carried out in such a way that acrylate polyols having average molar masses (Mn) of not more than 12 000 g/mol are present at the end of the reaction.

Homopolymers of hydroxyalkyl(meth)acrylates or copolymers of hydroxyalkyl(meth)acrylates with (meth)acrylic monomers which do not have hydroxyl functional groups are preferred. In particular, halogen-free monomers are employed in the preparation of the acrylate polyols used according to the invention.

The acrylate polyols used according to the invention are prepared in particular by polymerization of C₁- to C₈-hydroxyalkyl (meth)acrylates, e.g. hydroxyethyl(meth)acrylate, hydroxypropyl (meth)acrylate or hydroxybutyl(meth)acrylate.

Particularly suitable acrylic monomers without OH groups, which, if required, can be used as comonomers, are aliphatic monomers containing olefinic double bonds and having different chemical structures, for example alkenes of 2 to 6 carbon atoms, such as ethene, propene, butene or isobutene, or acrylonitrile, acrylamide, acrolein, maleic anhydride, vinyl esters of carboxylic acids or unsaturated carboxylic acids, such as maleic acid, fumaric acid or crotonic acid or derivatives thereof, and particularly preferably alkyl(meth)acrylates having C₁- to C₁₀-alkyl groups, for example n-hexyl(meth)acrylate, cyclohexyl (meth)acrylate, n-butyl(meth)acrylate, propyl(meth)acrylate, ethyl(meth)acrylate, methyl(meth)acrylate, ethylhexyl(meth)acrylate and/or hexanediol di(meth)acrylate. Said monomers can be used individually or as any desired mixtures with one another.

The acrylate polyols used according to the invention are preferably prepared by copolymerization of C₁- to C₈-hydroxyalkyl (meth)acrylates with the (meth)acrylic monomers described above and not having OH functional groups, it being possible for the different hydroxyalkyl(meth)acrylates to be combined as desired with the (meth)acrylates not having functional groups. Preferably, the OH-containing monomers are used in concentrations of from 2 to 98, particularly preferably from 5 to 98, mol %, based on the monomers used.

In a particularly advantageous embodiment of the present invention, the acrylate polyols are prepared by copolymerization of C₁- to C₈-hydroxyalkyl(meth)acrylates with alkyl (meth)acrylates having C₁- to C₁₀-alkyl groups.

The number average molar masses (Mn) of the acrylate polyols used according to the invention are particularly preferably from 1000 to 6000 g/mol, the average OH functionalities are from 1.8 to 20 and the OH numbers are from 15 to 500 mg KOH/g. At higher molecular weights and in particular at higher OH functionalities, the acrylate polyols are too highly viscous or solid and can therefore be processed in polyurethane systems only with difficulty.

The polyacrylate alcohols are preferably used in an amount of from 0.1 to 100, preferably from 0.5 to 50, particularly preferably from 1 to 30, parts by weight, based on 100 parts by weight of the compounds b) having at least two hydrogen atoms reactive with isocyanate groups.

Suitable compounds b) having at least two active hydrogen atoms, which can be employed together with the acrylate polyols used according to the invention, are in particular polyesteralcohols and preferably polyetheralcohols having an average functionality of from 2 to 8, in particular from 2 to 6, preferably from 2 to 4, and an average molecular weight of from 400 to 10 000, preferably from 1000 to 8000, g/mol.

The polyetheralcohols can be prepared by known processes, generally by catalytic addition reaction of alkylene oxides, in particular ethylene oxide and/or propylene oxide, with H-functional initiator substances, or by condensation of tetrahydrofuran. In particular, polyfunctional alcohols and/or amines are used as H-functional initiator substances. Water, dihydric alcohols, for example ethylene glycol, propylene glycol or butanediols, trihydric alcohols, for example glycerol or trimethylolpropane, and alcohols having a higher functionality, such as pentaerythritol, sugar alcohols, for example sucrose, glucose or sorbitol, are preferably used. Preferably used amines are aliphatic amines of up to 10 carbon atoms, for example ethylenediamine, diethylenetriamine or propylenediamine, and amino alcohols, such as ethanolamine, diethanolamine or triethanolamine. Preferably used alkylene oxides are ethylene oxide and/or propylene oxide, an ethylene oxide block frequently being attached at the chain end in the case of polyetheralcohols which are used for the preparation of flexible polyurethane foams. Catalysts used in the addition reaction of the alkylene oxides are in particular basic compounds, potassium hydroxide being of the greatest industrial importance here. If the content of unsaturated components in the polyetheralcohols is to be low, it is also possible to use multimetal cyanide compounds, i.e. DMC catalysts, as catalysts.

For the preparation of viscoelastic flexible foams and integral foams, in particular di- and/or trifunctional polyetheralcohols are used.

Di- and/or trifunctional polyetheralcohols which have primary hydroxyl groups, in particular those having an ethylene oxide block at the chain end or those which are based only on ethylene oxide, are preferably used for the preparation of flexible and semirigid foams by the novel process.

The compounds having at least two active hydrogen atoms also include the chain extenders and crosslinking agents, which, if required, may be present. Preferably used chain extenders and crosslinking agents are difunctional and trifunctional alcohols having molecular weights of less than 400, in particular from 60 to 150, g/mol. Examples are ethylene glycol, propylene glycol, diethylene glycol, 1,4-butanediol, glycerol and trimethylolpropane. Diamines may also be used as crosslinking agents. If chain extenders and crosslinking agents are used, their amount is preferably up to 5% by weight, based on the weight of the compounds having at least two active hydrogen atoms.

Polyisocyanates used may be the conventional and known aromatic di- and polyisocyanates, individually or as any desired mixtures with one another. Examples of aromatic di- or polyisocyanates are tolylene 2,4-diisocyanate (2,4-TDI), tolylene 2,6-diisiocyanate (2,6-TDI), diphenylmethane 2,4-diisocyanaate (2,4′-MDI), diphenylmethane 4,4′-diisocyanate (4,4′-MDI), polyphenylpolymethylene polyisocyanates, as prepared by condensation of aniline and formaldehyde and subsequent phosgenation (polymer MDI), p-phenylene diisocyanate, toluidine diisocyanate, xylylene diisocyanate or naphthylene 1,5-diisocyanate (NDI).

Together with or instead of these monomeric isocyanates or mixtures thereof, oligo- or polyisocyanates prepared therefrom, i.e. prepolymers, in particular based on TDI and MDI, are preferably used. These oligo- or polyisocyanates can be prepared from said di- or polyisocyanates or mixtures thereof and, if required, mono- or polyalcohols by linkage with urethane, allophanate, urea, biuret, uretdione, amide, isocyanurate, carbodiimide, uretonimine, oxadiazinetrione or iminooxadiazinedione structures. Polymers having urethane, allophanate, carbodiimide, uretonimine, biuret or isocyanurate groups obtained from TDI or MDI and, if required, mono- or polyalcohols are preferably used here.

Further starting materials, in particular catalysts, blowing agents and assistants and/or additives may be concomitantly used for carrying out the novel process, the following being stated specifically below concerning them:

Catalysts used for the preparation of the novel polyurethane foams are the conventional and known polyurethane formation catalysts, for example organic tin compounds, such as tin diacetate, tin dioctanoate or dibutyltin dilaurate, and/or strongly basic amines, such as diazabicyclooctane, diazabicyclononane, diazabicycloundecane, triethylamine, pentamethyldiethylenetriamine, tetramethyldiaminoethyl ether, imidazoles or preferably triethylenediamine or bis(N,N-dimethylaminoethyl)ether. Furthermore, carboxylic acid salts, e.g. potassium acetate, cesium acetate or tetraalkylammonium salts of carboxylic acids, are used. Recently, incorporatable catalysts which contain functional groups, such as hydroxyl, primary or secondary amino or other groups, which are capable of reacting with isocyanates have increasingly been used. These catalysts are incorporated into the polyurethane matrix by covalent bonding and cannot be emitted from the foam, which contributes toward less odor and generally lower emissions, as currently required on the market. Examples of such preferred, incorporatable catalysts are 3-aminopropylimidazole, N,N,N′-trimethyl-N′-hydroxyethylbisaminoethyl ether, 6-dimethylamino-1-hexanol, N-(2-hydroxypropyl)imidazole, bis(dimethylaminopropyl)amine and 2-(2-(N,N-dimethylamino)ethoxy)ethanol or, for example, the commercially available catalysts Dabco NE 200 and Dabco NE 1060. The catalysts are preferably used in an amount of from 0.01 to 10, particularly preferably from 0.05 to 5, % by weight.

The preferably used blowing agent for the preparation of polyurethane foams is water, which reacts with the isocyanate groups with liberation of carbon dioxide. Together with or instead of water, it is also possible to use physical blowing agents, for example carbon dioxide, hydrocarbons, such as n-pentane, isopentane, cyclopentane or cyclohexane, or halogenated hydrocarbons, such as tetrafluoroethane, pentafluoropropane, heptafluoropropane, pentafluorobutane, hexafluorobutane or dichloromonofluoroethane. The amount of the physical blowing agent is preferably from 1 to 15, in particular from 1 to 10, % by weight, and the amount of water is preferably from 0.5 to 10, in particular from 1 to 5, % by weight.

Assistants and/or additives used are, for example, surface-active substances, foam stabilizers, cell regulators, external and internal lubricants, fillers, flameproofing agents, pigments, hydrolysis stabilizers and fungistatic and bacteriostatic substances.

In the industrial production of polyurethane foams, it is usual to combine the compounds b) having at least two active hydrogen atoms and the further starting materials and the assistants and/or additives before the reaction to give a polyol component.

Further information about the starting materials used can be found, for example, in Kunststoffhandbuch, Volume 7, Polyurethane, edited by Günter Oertel, Carl-Hanser-Verlag, Munich, 3rd edition 1993.

For the preparation of the novel polyurethanes, the organic polyisocyanates a) are reacted with the compounds b) having at least two active hydrogen atoms and said blowing agents, catalysts and assistants and/or additives (polyol component), the acrylate polyols used according to the invention preferably being added to the polyol component.

In the preparation of the novel polyurethanes, isocyanate and polyol component are combined in an amount such that the ratio of the number of equivalents of isocyanate groups to the sum of the active hydrogen atoms, also referred to as the index, is from 0.6 to 1.4, preferably from 0.7 to 1.2. As mentioned, very flexible foams having viscoelastic properties are preferably prepared at an index of from 0.45 to 1.0, preferably from 0.55 to 0.95, particularly preferably from 0.6 to 0.9.

The polyurethane foams are preferably prepared by the one-shot process, for example with the aid of a high pressure or low pressure technique. The foams can be prepared in open or closed metallic molds or by continuous application of the reaction mixture to belt lines for producing slabstock foam.

It is particularly advantageous to employ the two-component process in which, as stated above, a polyol component and an isocyanate component are prepared and are foamed. The components are preferably mixed at from 15 to 120° C., more preferably from 20 to 80° C., and introduced into the mold or onto the belt line. The temperature in the mold is generally from 15 to 120° C., preferably from 30 to 80° C.

The acrylate polyols used according to the invention permit the preparation of resilient and viscoelastic flexible and semirigid foams having densities of less than 200 g/l and excellent mechanical properties, for example very good elongation, tensile strength and hardness. Surprisingly, the resilience of the polyurethane foams can be reduced by using the acrylate polyols, so that the desired viscoelastic properties are further enhanced.

The examples which follow illustrate the invention.

Table 1 shows polyacrylate polyols which can be used for the preparation of the novel foams.

TABLE 1
Examples of polyacrylate polyols

| | | Number | | |
|---|---|---|---|---|
| | | average | | |
| | Composition | molar | | |
| Polyacrylate | monomers | mass | Average OH | OH number |
| No. | (mol %) | (g/mol) | functionality | (mg KOH/g) |
| 1 | HEA/BA | 5090 | 2.5 | 28 |
| | 6:94 | | | |
| 2 | HEA/BA | 2100 | 2.6 | 72 |
| | 15:85 | | | |
| 3 | HEA/BA/EHA | 2950 | 2.5 | 48 |
| | 10:87.5:2.5 | | | |
| 4 | HEA/BA/EHA | 2900 | 2.5 | 48 |
| | 10:75:15 | | | |
| 5 | HEA/BA | 1890 | 4.1 | 121 |
| | 25:75 | | | |
| 6 | HEA/BA | 4960 | 2.3 | 26 |
| | 5.3/94.7 | | | |
| 7 | HEA/BA/EHA | 3900 | 2.6 | 29 |
| | 6:84:10 | | | |

BA: n-Butyl acrylate
HEA: 2-Hydroxyethyl acrylate
EHA: 2-Ethylhexyl acrylate

The other starting materials used for the preparation of the polyurethane foams are described below.

In order to simulate conditions as occur in special applications in which polyurethane materials are exposed to hydrolytic stresses and in order to obtain foams having measurable contents of aromatic amines, the foams prepared were subjected to storage under humid and warm conditions. For this purpose, in each case sample cubes having an edge length of 3 cm were stored at 90% relative humidity and 90° C. for 72 hours in a conditioned chamber. The subsequent extraction of the aromatic amines formed was carried out by means of a method developed by Prof. Skarping, University of Lund. For this purpose, the foam was pressed out 10 times in 10 ml of acetic acid (w=1% by weight). The acetic acid with the compressed foam sample was transferred to a 50 ml volumetric flask. The procedure was repeated twice and the volumetric flask then made up to the calibration mark with acetic acid (w=1% by weight). The MDA content of the combined extracts was then determined by means of capillary electrophoresis with UV detection (apparatus type: Biofocus 3000, measurement of the peak areas and comparison with imidazole as internal standard). The limit of detection of the capillary electrophoresis determination is 1 ppm. The MDA contents stated in the examples correspond to the absolute contents of the resulting MDA in the PU foam.

Molded flexible foams: reduction of the content of aromatic amines after storage under humid and warm conditions:

### EXAMPLE 1

### Comparative Example

For the preparation of a molded polyurethane flexible foam, 750 g of a polyol component comprising 97 parts by weight of Lupranol® 2090 (Elastogran GmbH), 3 parts by weight of Lupranol® 2047 (Elastogran GmbH), 3.31 parts by weight of water, 0.22 part by weight of triethylenediamine, 0.14 part by weight of Lupragen® N 206 (BASF Aktiengesellschaft) and 0.5 part by weight of Tegostab® B 8631 (Goldschmidt AG) were mixed with 350 g of an isocyanate component comprising 42 parts by weight of Lupranat® M 20 w (polymer MDI, Elastogran GmbH) and a mixture of 2,4′- and 4,4′-MDI (11 parts by weight of Lupranat® ME and 47 parts by weight of Lupranat® MI, Elastogran GmbH) at an index of 0.9, and the foaming mixture was introduced into an aluminum mold having the dimensions 40 cm×40 cm×10 cm and thermostated at 53° C.

The resulting foam contained no detectable amounts of MDA without aging and 32 ppm of 4,4′-MDA and 78 ppm of 2,4′-MDA after aging under humid and warm conditions.

### EXAMPLE 2

### According to the Invention

The procedure was as in example 1, except that 97 parts by weight of the acrylate polyol 1 from table 1 were used instead of Lupranol® 2090 in the polyol component. The foaming was likewise carried out at an index of 0.9.

The resulting foam contained no detectable amounts of MDA without aging and 6 ppm of 4,4′-MDA and 20 ppm of 2,4′-MDA after aging under humid and warm conditions.

It was found that the MDA content of the aged foam could be substantially reduced by using the novel acrylate polyol.

### EXAMPLE 3

### Comparative Example

The preparation of a molded flexible polyurethane foam was carried out by mixing 750 g of a polyol component as in comparative example 1, but in which 0.8 part by weight of 3-aminopropylimidazole was used instead of triethylenediamine and 0.8 part by weight of Lupragen® N 206 instead of 0.14 part by weight, with 360 g of the isocyanate component from comparative example 1 (index=1.0) and transferring the foaming mixture to an aluminum mold having the dimensions 40 cm×40 cm×10 cm and thermostated at 53° C.

The resulting foam contained no detectable amounts of MDA without aging and 397 ppm of 4,4′-MDA and 687 ppm of 2,4′-MDA after aging under humid and warm conditions.

### EXAMPLE 4

### According to the Invention

The procedure was as in example 3 (index=1.0), except that 48.5 parts of the acrylate polyol 1 from table 1 and only 48.5 parts of Lupranol® 2090 were used in the polyol component.

The resulting foam contained no detectable amounts of MDA without aging and 58 ppm of 4,4′-MDA and 127 ppm of 2,4′-MDA after aging under humid and warm conditions.

The MDA content of the aged foam could therefore be substantially reduced by using the novel acrylate polyol.

Flexible slabstock foams: reduction of the content of aromatic amines after storage under humid and warm conditions:

### EXAMPLE 5

### Comparative Example

For the preparation of a flexible slabstock polyurethane foam, 441 g of a polyol component comprising 100 parts by weight of Lupranol® 2080 (Elastogran GmbH), 2.7 parts by weight of water, 0.63 part by weight of Tegostab® BF 2370 and 0.17 part by weight of Kosmos® 29 (Goldschmidt AG), 0.09 part by weight of Lupragen® N 201 and 0.04 part of Lupragen® N 101 (BASF Aktiengesellschaft) were mixed with 159 g of tolylene diisocyanate (80/20 isomer mixture, Lupranat® T 80, Elastogran GmbH) at an index of 1.1 and the foaming mixture was introduced into a cardboard box open at the top and having the dimensions 22 cm×22 cm×22 cm.

The resulting foam contained no detectable amounts of TDA without aging and 33 ppm of 2,4-TDA and 9 ppm of 2,6-TDA after aging under humid and warm conditions.

### EXAMPLE 6

### According to the Invention

The procedure was as in example 5, except that 50 parts of Lupranol 2080 and 50 parts of acrylate polyol 3 (table 1) were used in the polyol component. The foaming was likewise carried out at an index of 1.1.

The resulting foam contained no detectable amounts of TDA without aging and 20 ppm of 2,4-TDA and 7 ppm of 2,6-TDA after aging under humid and warm conditions.

The TDA content of the aged foam could therefore be substantially reduced by using the novel acrylate polyol.

### EXAMPLE 7

### According to the Invention

The procedure was as in example 5, except that only 1.7 parts of Lupranol 2080 and 98.3 parts of the acrylate polyol 3 (table 1) were used in the polyol component. The foaming was likewise carried out at an index of 1.1.

The resulting foam contained no detectable amounts of TDA without aging and 11 ppm of 2,4-TDA and 4 ppm of 2,6-TDA after aging under humid and warm conditions.

The TDA content of the aged foam could therefore be substantially reduced by using the novel acrylate polyol.

### EXAMPLE 8

### According to the Invention

The procedure was as in example 5, except that 70 parts of Lupranol 2080 and 30 parts of the acrylate polyol 6 (table 1) were used in the polyol component. The foaming was likewise carried out at an index of 1.1.

The resulting foam contained no detectable amounts of TDA without aging and 13 ppm of 2,4-TDA and 3 ppm of 2,6-TDA after aging under humid and warm conditions.

The TDA content of the aged foam could therefore be substantially reduced by using the novel acrylate polyol.

### EXAMPLE 9

### According to the Invention

The procedure was as in example 5, except that 30 parts of Lupranol 2080 and 70 parts of the acrylate polyol 6 (table 1) were used in the polyol component. The foaming was likewise carried out at an index of 1.1.

The resulting foam contained no detectable amounts of TDA without aging and 10 ppm of 2,4-TDA and 3 ppm of 2,6-TDA after aging under humid and warm conditions.

The TDA content of the aged foam could therefore be substantially reduced by using the novel acrylate polyol.

### EXAMPLE 10

### According to the Invention

The procedure was as in example 5, except that only 1.7 parts of Lupranol 2080 and 98.3 parts of the acrylate polyol 6 (table 1) were used in the polyol component. The foaming was likewise carried out at an index of 1.1.

The resulting foam contained no detectable amounts of TDA without aging and 9 ppm of 2,4-TDA and 3 ppm of 2,6-TDA after aging under humid and warm conditions.

The TDA content of the aged foam could therefore be substantially reduced by using the novel acrylate polyol.

Establishing viscoelasticity or resilience in the case of viscoelastic flexible slabstock foams.

In comparison with the standard system (comparative example 11), the addition of acrylate polyols substantially reduces the resilience of the foams.

### EXAMPLE 11

### Comparative Example

A flexible polyurethane foam was prepared by mixing 1000 g of a polyol component comprising 100 parts by weight of Lupranol® 2080 (Elastogran GmbH), 2.65 parts by weight of water, 0.25 part by weight of Lupragen® N 101 (BASF Aktiengesellschaft), 0.04 part by weight of Lupragen® N 206 (BASF Aktiengesellschaft), 0.2 part by weight of Kosmos® 29 (Goldschmidt AG) and 0.8 part by weight of Tegostab® BF 2370 (Goldschmidt AG) with 374 g of tolylene diisocyanate (80/20 isomer mixture, Lupranat® T 80, Elastogran. GmbH), index=1.15, and transferring the foaming mixture to a box open at the top and having the dimensions 40 cm×40 cm×40 cm.

The resilience of the resulting foam is shown in table 2′.

### EXAMPLE 12

### According to the Invention

The procedure was as in example 11, except that 5 parts of the acrylate polyol 2 from table 1 and 95 parts of Lupranol 2080 were used in the polyol component. The foaming was likewise carried out at an index of 1.15.

The resilience is shown in table 2.

### EXAMPLE 13

### According to the Invention

The procedure was as in example 11, except that 10 parts of the acrylate polyol 2 from table 1 and 90 parts of Lupranol 2080 were used in the polyol component. The foaming was likewise carried out at an index of 1.15.

The resilience is shown in table 2.

### EXAMPLE 14

### According to the Invention

The procedure was as in example 11, except that 20 parts of the acrylate polyol 2 from table 1 and 80 parts of Lupranol 2080 were used in the polyol component. The foaming was likewise carried out at an index of 1.15.

The resilience is shown in table 2.

TABLE 2

| Foam from: | Resilience | Density |
|---|---|---|
| Example 11 | 51% | 36.6 kg/m³ |
| Example 12 | 43% | 35.5 kg/m³ |
| Example 13 | 33% | 34.9 kg/m³ |
| Example 14 | 22% | 32.7 kg/m³ |

As shown in table 2, the resilience can be substantially reduced in the case of conventional slabstock foams of comparable density by adding a suitable acrylate polyol, so that viscoelastic foams form.

Semirigid foams: Improvement of the aging resistance.

### EXAMPLE 15

### Comparative Example

For the preparation of a semirigid polyurethane foam, a polyol component comprising 92 parts by weight of Lupranol® 2090 (Elastogran GmbH), 8 parts by weight of polyol PP50 (Perstorp AB), 2 parts by weight of an amine-initiated polyoxypropylenediol, hydroxyl number 250, 2.81 parts by weight of water, 0.26 part by weight of Jeffcat® ZF10 (Huntsman Corporation) and 0.26 part by weight of potassium acetate (47% strength in ethylene glycol) was mixed with an isocyanate component consisting of a mixture of 31.5 parts by weight of Lupranat® M 20 W (polymer MDI, Elastogran GmbH) and 68.5 parts by weight of a prepolymer (NCO content 26%) of Lupranat® MM103, Lupranat® ME (Elastrogan GmbH) and tripropylene glycol at an index of 0.97 and the foaming mixture was introduced into an aluminum mold thermostated at 44° C. and having the dimensions 20 cm×20 cm×4 cm and a cushion having a density of 95 kg/m³ was obtained.

The percentage decrease in the tensile strength or the elongation after storage under warm conditions (7 days at 140° C.) was 35% and 60%, respectively.

The percentage decrease in the compressive strength at 40% compression was 53% after storage under humid and warm conditions (5 h 120° C. at 100% relative humidity, 3 cycles).

### EXAMPLE 16

### According to the Invention

The procedure was as in example 1, except that 61 parts by weight of Lupranol® 2090, instead of 92 parts by weight of Lupranol® 2090, and 31 parts by weight of the acrylate polyol 7 from table 1 were used in the polyol component. Furthermore, the content of the polyol PP50 was reduced from 8 parts by weight to 2 parts by weight and 0.25 part of Tegostab® BF 2370 (Goldschmidt AG) was additionally used. The density of the resulting cushion was 77 kg/m³.

The percentage decrease in the tensile strength or elongation after storage under warm conditions (7 days 140° C.) was 18% and 40%, respectively.

The percentage decrease in the compressive strength at 40% compression was 37% after storage under humid and warm conditions (5 h 120° C. at 100% relative humidity, 3 cycles).

1. A process for the preparation of polyurethane foams having a density of less than 200 g/l, by comprising reacting
a) a polyisocyanate with
b) a compound having at least two hydrogen atoms reactive with an isocyanate group,
wherein the polyisocyanate a) is an aromatic di- or polyisocyanate and the compound b) having at least two hydrogen atoms reactive with an isocyanate group contains at least one acrylate polyol having a hydroxyl number between 15 and 500 mg KOH/g, which can be prepared by copolymerization of hydroxyl-functionalized (meth)acrylates with ethene, propene, butene, isobutene, diisobutene, acrylonitrile, acrylamide, acrolein, styrene, methylstyrene, divinylbenzene, maleic anhydride, vinyl esters of carboxylic acids or unsaturated carboxylic acids, for example maleic acid, fumaric acid or crotonic acid or derivatives thereof, and at least one polyether alcohol or polyester alcohol.

2. A process as claimed in claim 1, wherein the acrylate polyol has an average molecular weight Mn of not more than 12 000 g/mol.

3. A process as claimed in claim 1, wherein the acrylate polyol has an average molecular weight Mn of not more than 8000 g/mol.

4. A process as claimed in claim 1, wherein the acrylate polyol has an average molecular weight Mn of not more than 6000 g/mol.

5. A process as claimed in claim 1, wherein the acrylate polyol is prepared by polymerization of hydroxyl-functionalized (meth)acrylates.

6. A process as claimed in claim 1, wherein the acrylate polyol is prepared by copolymerization of hydroxyl-functionalized (meth)acrylates with monomers containing olefinic double bonds and no hydroxyl functional groups.

7. A process as claimed in claim 1, wherein the acrylate polyol is prepared by copolymerization of hydroxyl-functionalized (meth)acrylates with (meth)acrylates having no hydroxyl functional groups.

8. A process as claimed in claim 1, wherein the acrylate polyol is prepared by polymerization of C₁- to C₈-hydroxyalkyl(meth)acrylates.

9. A process as claimed in claim 1, wherein the acrylate polyol is prepared by copolymerization of C₁- to C₈-hydroxyalkyl(meth)acrylates with alkyl(meth)acrylates having C₁- to C₁₀-alkyl groups.

10. A process as claimed in claim 1, wherein the acrylate polyol is used in an amount of from 0.1 to 50 parts by weight, based on 100 parts by weight of the compound b) having at least two hydrogen atoms reactive with isocyanate groups.

11. A process as claimed in claim 1, wherein the acrylate polyol is used in an amount of from 0.5 to 40 parts by weight, based on 100 parts by weight of the compound b) having at least two hydrogen atoms reactive with isocyanate groups.

12. A process as claimed in claim 1, wherein the acrylate polyol is used in an amount of from 1 to 30 parts by weight, based on 100 parts by weight of the compound b) having at least two hydrogen atoms reactive with isocyanate groups.

13. A process as claimed in claim 1, wherein the polyisocyanate a) is selected from the group consisting of tolylene diisocyanate, diphenylmethane diisocyanate, polyphenylpolymethylene polyisocyanate, phenylene diisocyanate, xylylene diisocyanate, naphthylene diisocyanate, tolidine diisocyanate and mixtures thereof.

14. A process as claimed in claim 1, wherein the polyisocyanate a) is modified by incorporation of urethane, allophanate, urea, biuret, uretdione, amide, isocyanurate, carbodiimide, uretonimine, oxadiazinetrione or iminooxadiazinedione structures.

15. A process as claimed in claim 1, wherein the polyisocyanate a) is modified by incorporation of urethane, allophanate, uretdione, carbodiimide, uretonimine, biuret or isocyanurate structures.

16. A polyurethane foam prepared by the process as claimed in claim 1.

17. A polyol blend for the preparation of polyurethane foams, comprising at least one acrylate polyol and at least one polyetheralcohol or polyesteralcohol.
